(19) United States
(12) Patent Application Publication
(10) Pub. No.: US 2020/0390525 A1
(43) Pub. Date: Dec. 17, 2020

(54) ORTHODONTIC DEVICE

(71) Applicants: Yi-Wen Chen, New Taipei City (TW); Hsi-Yuan Lin, New Taipei City (TW)

(72) Inventors: Yi-Wen Chen, New Taipei City (TW); Hsi-Yuan Lin, New Taipei City (TW); Chih-Chang Tsai, New Taipei City (TW)

(21) Appl. No.: 16/438,420

(22) Filed: Jun. 11, 2019

(51) Int. Cl. A61C 7/28; A61C 7/14

(52) U.S. Cl. CPC A61C 7/287; A61C 7/20; A61C 7/14

(57) ABSTRACT

The orthodontic device includes a base member for attaching to a tooth, a wire duct on the base member, a channel besides the wire duct, a cover element slidably configured on the base member, a positioning element embedded to the cover element, a flexible block inside the positioning element, a roller rotatably positioned between the channel and the positioning element, and a filler for sealing the channel As the roller facilitates the opening and closing of the cover element, the flexible block provides an inward deformation capability to the positioning element, thereby reducing the wear between the roller and the positioning element. The cover element as such may be repeatedly and reliably opened and closed. The limitation by the filler to the roller provides assembly convenience.

### BACKGROUND OF THE INVENTION

### (a) Technical Field of the Invention

The present invention is generally related to orthodontics, and more particular to an orthodontic device that is convenient to assemble and reliable for repeated use.

### (b) Description of the Prior Art

Dental braces (also known as braces) are devices used in orthodontics that align and straighten teeth and help position them. Braces are often used to correct underbites, malocclusions, overbites, open bites, deep bites, cross bites, crooked teeth, and various other flaws of the teeth.

Usually a flexible arch wire is bended and twisted, and then joined to a number of brackets. The brackets are then attached to a patient's teeth, which, under the pressure of the arch wire, are directed to their desired positions.

An orthodontic treatment process often takes one to two years. In the process, the arch wire has to be periodically reinstalled, leading to wear between the brackets' cover and base and inferior positioning of the arch wire.

### SUMMARY OF THE INVENTION

Therefore, a major objective of the present invention is to provide an orthodontic device capable of reducing wear and enhancing arch wire positioning.

To achieve the objective, the orthodontic device includes a base member for attaching to a front face of a tooth, a wire duct on a front side the base member, a channel extending through the base member perpendicularly to and beneath the wire duct, a cover element slidably configured on the front side of the base member for covering a front opening of the wire duct, a positioning element embedded to a back side of the cover element, a roller rotatably positioned between the channel and the positioning element, and a filler for sealing the channel. The positioning element includes a flexible block, a roller duct configured vertically on a back side of the flexible block, and at least a roller recess at an end of the roller duct.

To apply the orthodontic device, the base member is attached to a patient's tooth, and the arch wire is received in the wire duct, which in turn is sealed by the cover element. Subsequently, if there is a need for adjusting the arch wire, it may be conducted conveniently after opening the cover element. The positioning of the cover element is achieved through the engagement between the roller and the positioning element. The roller, on the other hand, moves between the roller duct and the roller recess through the deformation of the flexible block. This approach also lessens the wear between the roller and the positioning element, thereby contributing to the repeated usage of the cover element. Additionally, due to the way how the filler is fixed, the base member may be made of different materials without sacrificing the assembly convenience.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an orthodontic device according to a first embodiment of the present invention.

FIG. 2 is a perspective breakdown diagram showing the orthodontic device of FIG. 1 from a different angle.

FIG. 3 is a cross-sectional diagram showing the orthodontic device of FIG. 1 across the A-A line.

FIG. 4 is a schematic cross-sectional diagram showing how the orthodontic device of FIG. 1 is packaged.

FIG. 5 is a schematic perspective diagram showing how the orthodontic device of FIG. 1 is applied.

FIG. 6 is a schematic cross-sectional diagram showing when a cover element of the orthodontic device of FIG. 1 reveals a wire duct.

FIG. 7 is a schematic cross-sectional diagram showing when a cover element of the orthodontic device of FIG. 1 closes a wire duct.

FIG. 8 is a perspective diagram showing the orthodontic device of FIG. 1 where an additional limiting rod is applied.

FIG. 9 is a perspective breakdown diagram showing an orthodontic device according to a second embodiment of the present invention.

FIG. 10 is a cross-sectional diagram showing the orthodontic device of FIG. 9.

FIG. 11 is a schematic cross-sectional diagram showing when a cover element of the orthodontic device of FIG. 9 reveals a wire duct.

FIG. 12 is a perspective breakdown diagram showing an orthodontic device according to a third embodiment of the present invention.

FIG. 13 is a cross-sectional diagram showing the orthodontic device of FIG. 12 where a channel of a base member is sealed.

FIG. 14 is a schematic cross-sectional diagram showing when a cover element of the orthodontic device of FIG. 12 closes a wire duct.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

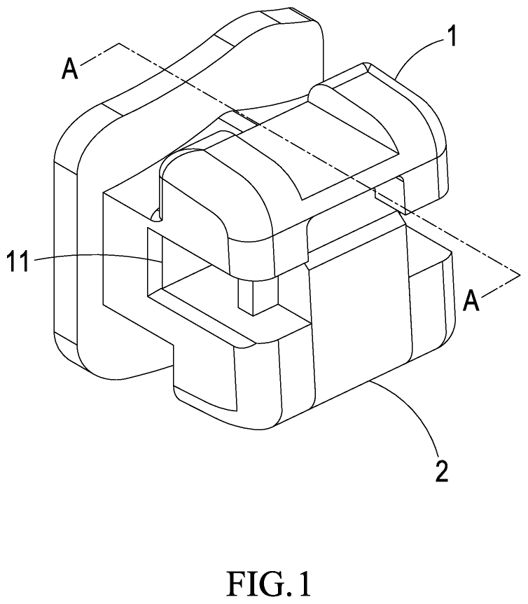

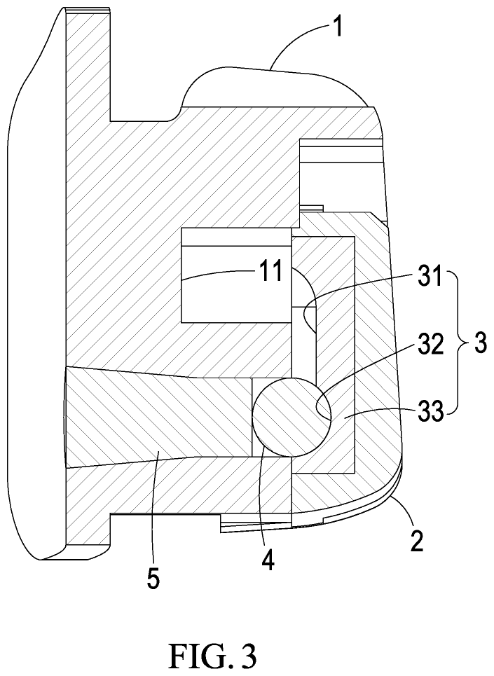

As shown in FIGS. 1 to 3, an orthodontic device according to a first embodiment of the present invention includes:

A base member 1 for attaching to a front face of a tooth;

a wire duct 11 on a front side the base member 1;

a channel 12 extending through the base member 1 perpendicularly to and beneath the wire duct 11;

a cover element 2 slidably configured on the front side of the base member 1 for covering a front opening of the wire duct 11;

a positioning element 3 embedded to a back side of the cover element 2.

The positioning element 3 includes a flexible block 33, a roller duct 31 configured vertically on a back side of the flexible block 33, and at least a roller recess 32 at an end of the roller duct 31;

a roller 4 rotatably positioned between the channel 12 and the positioning element 3; and

a filler 5 for plugging the channel 12 and pushing the roller 4.

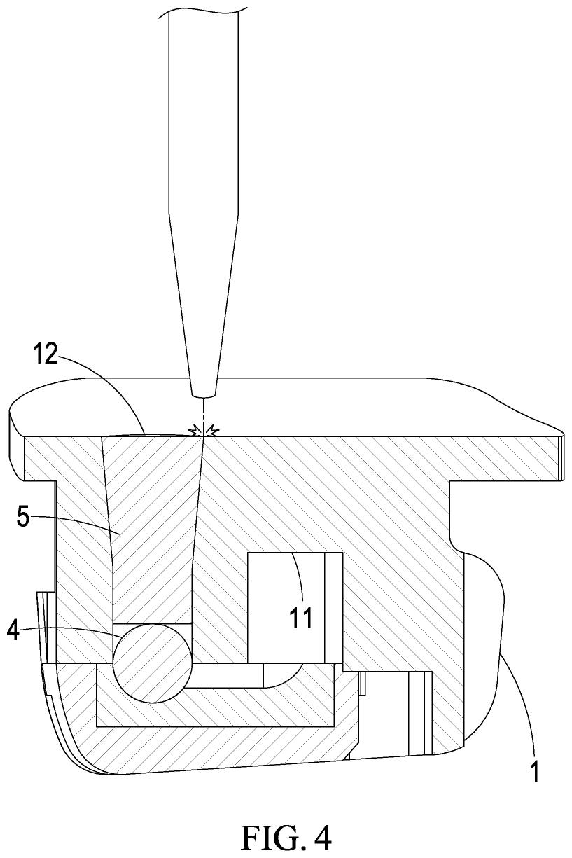

As shown in FIGS. 1 to 8, the orthodontic device of the present invention is shaped similarly to an ordinary bracket of a dental brace. The orthodontic device, however, has the roller 4, the flexible block 33, and the filler 5 jointly providing a reliable cover element 2. The orthodontic device also may be quickly assembled. As shown in FIG. 4, the base member 1 of the present embodiment is made of a metallic material. The base member 1, the wire duct 11, and the channel 12 are integrally formed. To assemble the orthodontic device, the roller 4 (which is a sphere in the present embodiment) is placed in the channel 12, the filler 5 is then plugged into the channel 12, the filler 5 is fixed to the base member 1 by laser welding, and the channel 12 is sealed.

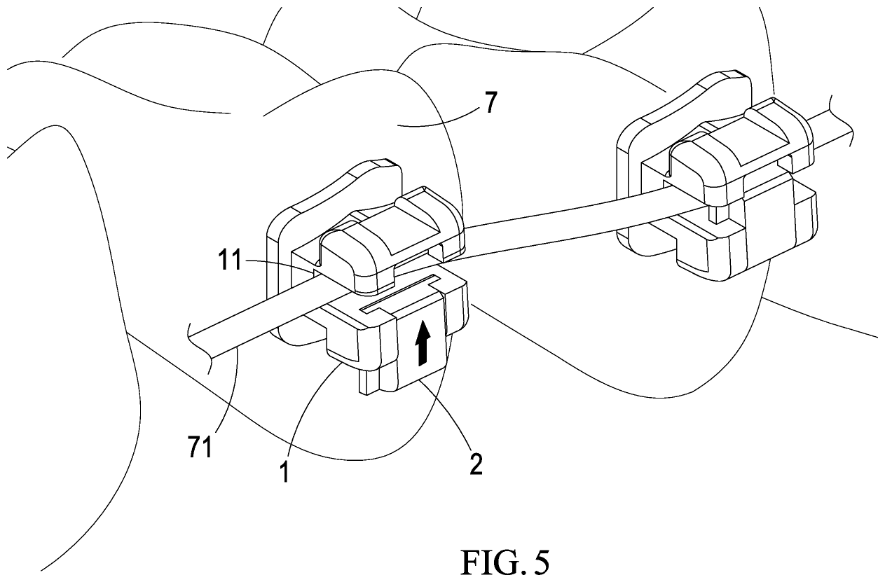

When the orthodontic device is put to use, as shown in FIG. 5, the base member 1 has its back side adhered to a front face 7 of a tooth, and an arch wire 71 is threaded through the wire duct 11. After the arch wire 71 is adjusted, the cover element 2 is moved upward to seal the front opening of the wire duct 11, thereby affixing the arch wire 71.

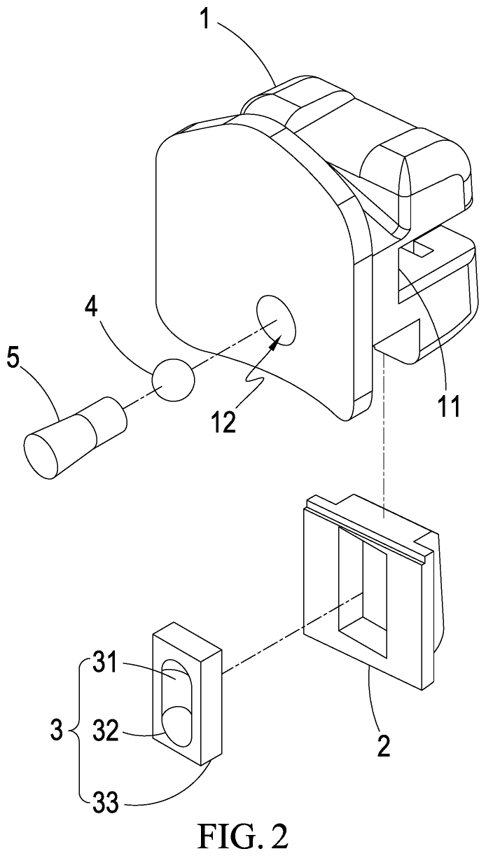

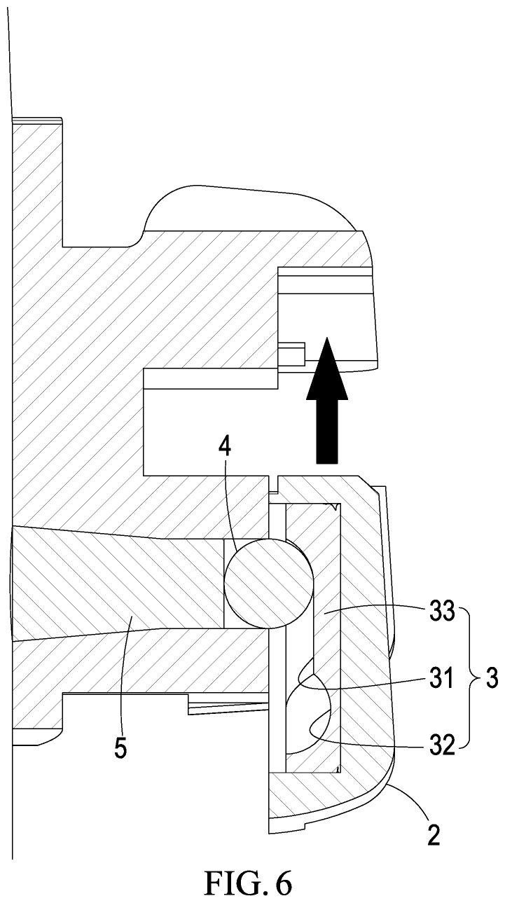

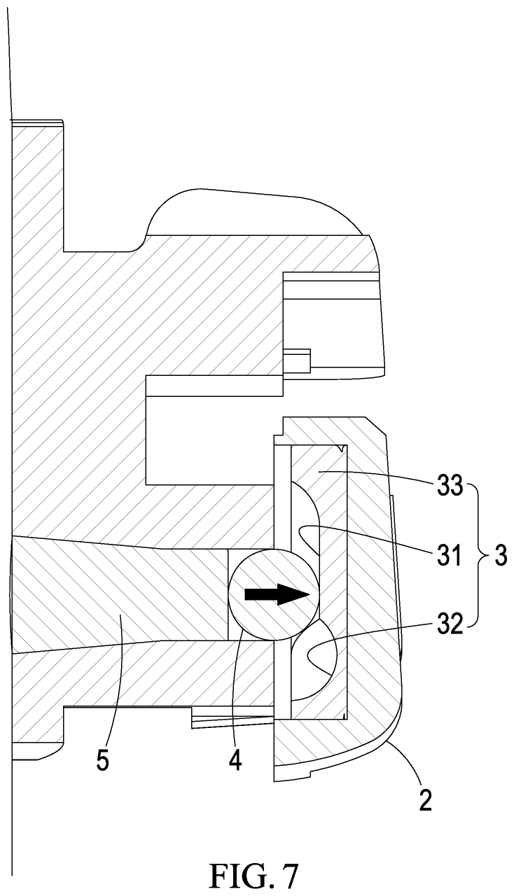

As shown in FIGS. 6 and 7, when the cover element 2 is in an open state, the roller 4 is inside the roller duct 31 of the positioning element 3. The roller duct 31 has a smooth or curved surface and, therefore, the cover element 2 may smoothly move relatively to the roller 4. The roller duct 31 has a depth smaller than that of the roller 4's diameter. As such, the roller 4 would exert a pressure on the flexible block 33 and the flexible block 33 is deformed as such. The flexible block 33 then would accumulate a certain amount of energy. When the roller 4 is moved into the roller recess 32 of the positioning element 3, the cover element 2 would be in a close state, sealing the front opening of the wire duct 11. The roller recess 32 has a greater depth than that of the roller duct 31, and the roller recess 32 has a shape comparable to that of the roller 4. As the roller recess 32 and the roller 4 are tightly fit together and, as the flexible block 33 releases its accumulated energy to press the roller 4, the roller 4 is reliably held in the roller recess 32, thereby positioning the cover element 2 as shown in FIG. 2.

Therefore, even for an extended treatment process where the cover element 2 would be opened and closed multiple times, the wear between the roller 4 and the positioning element 3 is mitigated by the design of the flexible block 33.

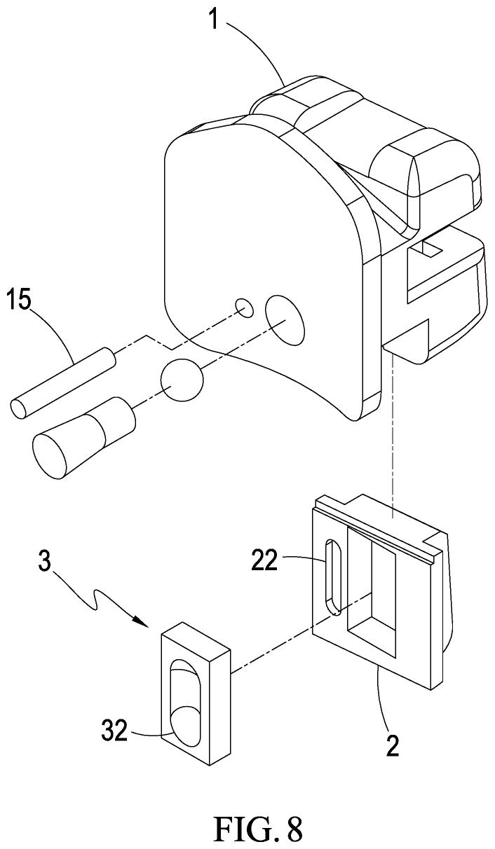

Additionally, as shown in FIG. 8, as there is a single roller recess 32 in the positioning element 3 of the present embodiment, the cover element 2 may break from the base member 1 when it is opened. A limiting rod 15 may be applied through the base member 1 into a limiting slot 22 on the back side of the cover element 2 to a side of the positioning element 3 to guarantee that the cover element 2 does not escape from the base member 1.

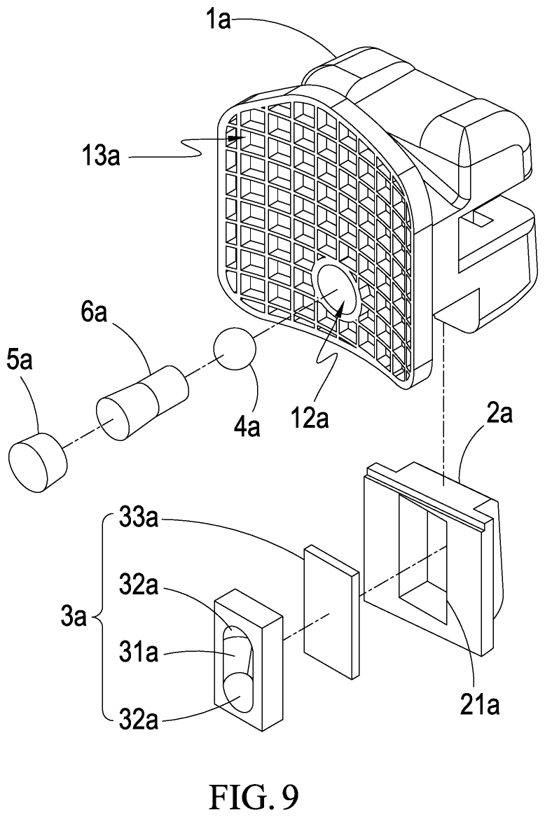

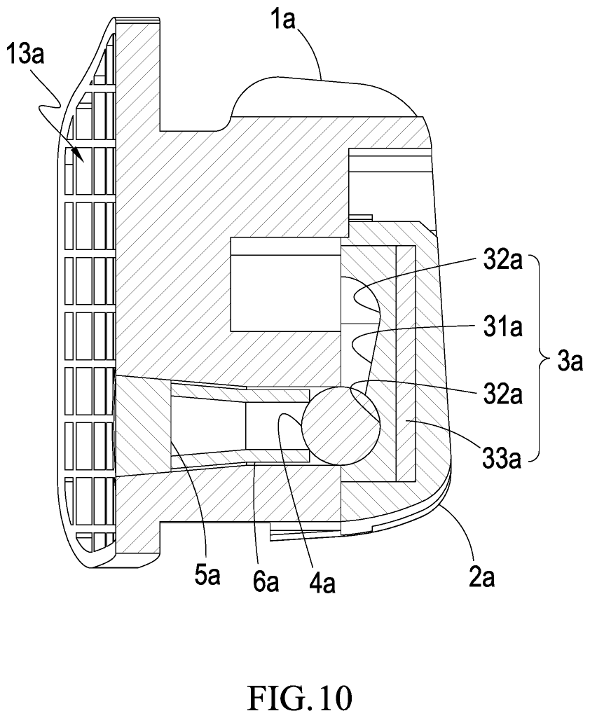

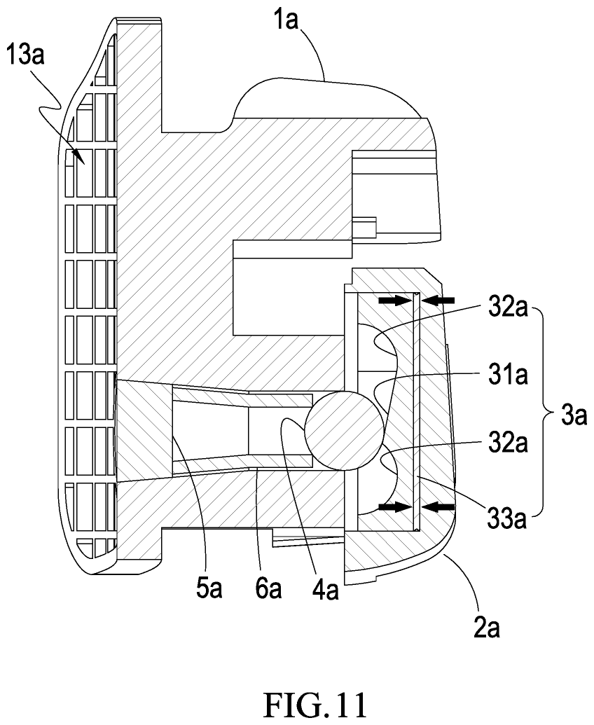

In a second embodiment of the present invention shown in FIGS. 9 to 11, a separate flexible block 33a is placed inside the cover element 2a's indentation 21a in front of the positioning element 3a. The cover element 2a or the positioning element 3a may be made of a metallic, polymeric, or ceramic material having no flexibility. It is the flexible block 33a that provides flexibility and deformation. Then, the pressure from the filler 5a on the roller 4a depresses the flexible block 33a, enhancing the cover element 2a's anti-wear capability. Alternatively, as shown in FIG. 9, another form of pressing the roller 4a is to have at least a support element 6a housed in the channel 12a between the filler 5a and the roller 4a.

A grid 13a is provided on the bottom side of the base member 1a so that the adhesive for adhering the base member 1a to the tooth may have a greater contact area with the base member 1a, thereby enhancing the adhesion strength of the base member 1a. Furthermore, there are two roller recesses 32a in the present embodiment, on at each end of the roller duct 31a. Then, regardless when the cover element 2a is opened or closed, the roller 4a would always be reliably held in one of the roller recesses 32a.

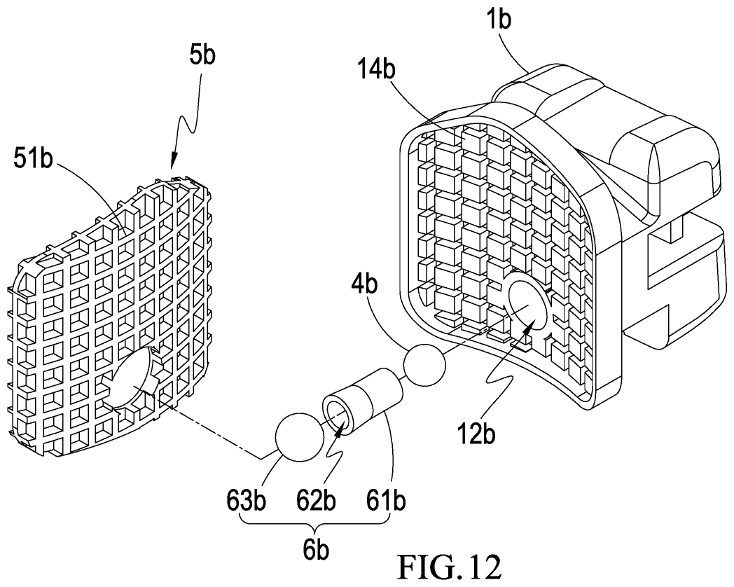

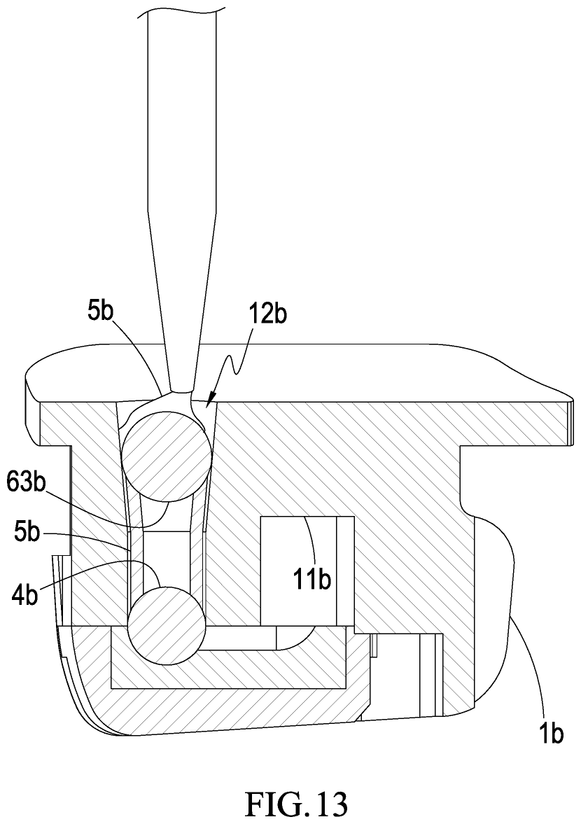

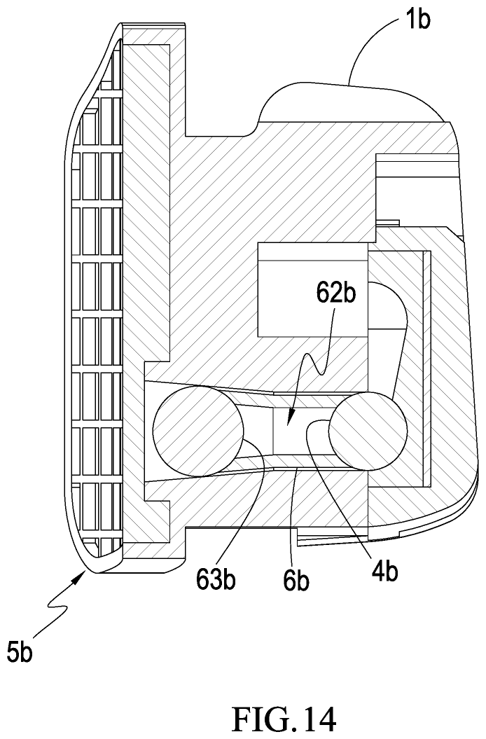

In a third embodiment shown in FIGS. 12 to 14, the base member 1b is made of a ceramic material, and the support element 6b includes a tubular body 61b, a channel 62b extending axially through the tubular body 61b, and a limiting roller 63b at an end of the tubular body 61b away from the roller 4b. The base member 1b, wire duct 11b, and channel 12b are still integrally formed. To assemble, the roller 4b, tubular body 61b, and limiting roller 63b are sequentially placed into the channel 12b from the back side of the base member 1b. UV curable resin (i.e., filler 5b) is then coated onto the limiting roller 63b to seal the channel 12b. As shown in FIG. 14, the spherical limiting roller 63b, with its greater spherical surface area, enhances the adhesion effect of the filler 5b while positioning the roller 4b at the same time.

The tubular body 61b is positioned between the roller 4b and the limiting roller 63b and, therefore, is not affected by the filler 5b, thereby providing normal limiting effect to the roller 4b. In the meantime, the roller 4b is partially received in the channel 62b, and thereby is provided with more stable support and limiting from the tubular body 61b.

The grid 5b's front side also has a grid structure 51b, and the base member 1b has an array of blocks 14b fitting into the grid structure 51b. To assemble, the roller 4b, support element 6b, and limiting roller 63b are sequentially placed inside the channel 12b, the grid 5b is then attached to the back side of the base member 1b. The affixation of the grid 5b to the base member 1b is achieved in the present embodiment through the locking between a large number of grid cells and array blocks, thereby securing the combination between the grid 5b and the base member 1b. Alternatively, hooks may be provided along the edges of the grid 5b and notches along the edges of the base member 1b so that they may engage each other to secure the combination between the grid 5b and the base member 1b.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. An orthodontic device, comprising:
a base member for attaching to a front face of a tooth;
a wire duct on a front side the base member;
a channel extending through the base member perpendicularly to and beneath the wire duct;
a cover element slidably configured on the front side of the base member for covering a front opening of the wire duct;
a positioning element embedded to a back side of the cover element, where the positioning element comprises a flexible block, a roller duct configured vertically on a back side of the flexible block, and at least a roller recess at an end of the roller duct;
a roller rotatably positioned between the channel and the positioning element; and
a filler for sealing the channel.

2. The orthodontic device according to claim 1, wherein the filler comprises a support element housed in the channel to a side of the roller away from the cover element.

3. The orthodontic device according to claim 2, wherein the support element comprises a tubular body and a channel extending axially through the tubular body.

4. The orthodontic device according to claim 3, wherein the support element further comprises a limiting roller at an end of the tubular body away from the roller.

5. The orthodontic device according to claim 1, wherein a limiting rod is applied through the base member into a limiting slot on the back side of the cover element located to a side of the positioning element to guarantee that the cover element does not escape from the base member.

6. The orthodontic device according to claim 1, wherein the filler is an UV curable resin.

7. The orthodontic device according to claim 1, the base member has an array of blocks on the back side; and a grid structure fits on the array of blocks.

8. The orthodontic device according to claim 1, wherein a grid is provided on a back side of the base member.

9. The orthodontic device according to claim 1, wherein the base member is made of a metallic material or a ceramic material.

10. The orthodontic device according to claim 2, wherein the roller has a spherical shape; and the support element has a cylindrical shape.
